(19) United States
(12) Patent Application Publication
(10) Pub. No.: US 2006/0144979 A1
(43) Pub. Date: Jul. 6, 2006

(54) Hydraulically adjustable cone crusher and an axial bearing assembly of a crusher

(75) Inventors: Ilpo K. Nieminen, Siivikkala (FI); Aki J. Lautala, Tampere (FI); Kari O. Kuvaja, Toijala (FI)

Correspondence Address: OLIFF & BERRIDGE, PLC, P.O. BOX 19928, ALEXANDRIA, VA, 22320, US

(73) Assignee: METSO MINERALS (TAMPERE) OY, Tampere (FI)

(21) Appl. No.: 11/262,875

(22) Filed: Nov. 1, 2005

(30) Foreign Application Priority Data
Dec. 20, 2004 (FI) 20041635

(51) Int. Cl. B02C 7/08

(52) U.S. Cl. 241/259

(57) ABSTRACT

A hydraulically adjustable cone crusher and a axial bearing assembly of a cone crusher, which crusher comprises an hydraulic adjustment cylinder/piston assembly mounted in the space formed between the crushing head and the upper surface of the main shaft for adjusting the setting of the crusher. The pressure medium of the hydraulic adjustment system of the crusher is supplied to the pressure medium space formed, except by the adjustment cylinder/piston assembly, also by at least one bearing element.

### BACKGROUND OF THE INVENTION

The present invention relates to cone crushers. More precisely, the invention concerns a hydraulic setting adjustment system of a cone crusher and an axial bearing assembly suitable for use in the setting adjustment system of a cone crusher.

Known in the patent literature, as well as by those skilled in the art, there are several different crushers, in which the crushing of stones or corresponding hard materials is effected in a crushing chamber defined by two crushing tools having substantially a form of truncated circular cones. This kind of a crusher is called cone crusher.

It is essential for the quality of the crushed final product that the form of the crushing chamber does not change substantially during the crushing procedure. Essential for the grain size of the produced crushed aggregate is the so called setting of the crusher, in other words, the minimum distance between the crushing tools during a working cycle of the crusher. When the crushing tools wear, the setting of the crusher will be, however, changed. In order to compensate this change, different setting adjustment solutions have been used in crushers already for a long time. Several solutions of this kind are known in the patent literature as well as by those skilled in the art. Many of those are hydraulically driven.

Finnish patent application FI-20040585 (Nieminen et al.) discloses a hydraulically adjustable cone crusher, wherein a piston-cylinder assembly of the hydraulic adjustment system is located in a space between the upper end of the main shaft, attached immobile into the frame, and the crushing head mounted movably with respect to the frame around the upper end of the main shaft. In this way, a crusher with small outer dimensions is provided without having to compromise over the size of the crushing chamber and thereby over the capacity of the crusher.

The publication discloses two different hydraulic adjustment solutions, one of those having the adjustment piston as the lower portion of the piston-cylinder pair and the other having the adjustment piston as the upper portion of the piston/cylinder pair.

In accordance with said patent publication, the pressure medium required for the setting adjustment of the crusher is supplied to the pressure medium space of the hydraulic setting adjustment cylinder via flexible hose in a lubricant channel extending inside the main shaft of the crusher. In accordance with one embodiment of said publication, the hose is attached at its upper end to an extension of the lower end of the adjustment piston, said extension extending through the axial bearing assembly of the crusher, and said extension, as well as the piston itself include a channel for supplying pressure medium through the piston into the pressure medium space of the adjustment cylinder. In accordance with another embodiment of said publication, the hose is attached at its upper end to an extension of the lower end of the adjustment cylinder, said extension extending through the axial bearing assembly of the crusher, and said extension, as well as the bottom of the cylinder itself include a channel for supplying pressure medium to the adjustment cylinder, to the pressure medium space below the piston.

The hydraulic cylinder/piston assembly 12, 13 of the setting adjustment system of the crusher can naturally be arranged by means of a hydraulic control circuit (not shown) of the crusher to operate as a safety device in situations, where some uncrushable material, for example solid metal, gets by mistake into the crushing chamber of the crusher among the feed material. In this kind of situations, the hydraulic cylinder-piston-assembly 12, 13 can be arranged by means of the control circuit to operate so, that when uncrushable material gets into the crushing chamber and the hydraulic control system discovers abnormal increase of the hydraulic pressure in the pressure medium space of the setting adjustment system, pressure medium will be discharged from the setting adjustment system in order to decrease the pressure and to enlarge the setting of the crusher, so that the uncrushable material can leave the crushing chamber without causing any damage to the crusher. This kind of an operation is known from the crushers of prior art, having a hydraulic cylinder-piston assembly as a setting adjustment system. The solution in accordance with said Finnish patent application FI-20040585 for supplying adjustment pressure medium has certain weaknesses. The construction is demanding for the pressure medium hose to be used. It must withstand many kinds of stresses: bending, twisting, pulsating changes of the pressure as well as fatigue loading caused by these together and separately. Thus, these solutions turn out to be unreliable in operation. In case the above-mentioned drawbacks should be eliminated by the hose material choice, the solution will also be expensive.

One drawback of the solution is also the fact that a quite large central aperture must be made to the lower bearing of the axial bearing assembly for the extension of the lower end of the adjustment piston or the adjustment cylinder, said extension extending through the axial bearing assembly, for allowing the movement of the extension when the crusher is in operation. In the solutions in accordance with said patent application the adjustment piston or adjustment cylinder with its lower end extension is an element moving laterally with respect to the lower bearing of the axial bearing assembly. The large central aperture means that the supporting area of the bearing surfaces of the axial bearing assembly are quite small compared to their total surface area, whereby the ability of the crusher to bear vertical crushing loads remains small. This means, in fact, decreasing capacity of the crusher.

For compensating the effect of the large central aperture, the outer diameters of the bearing surface of the axial bearing assembly should be increased, whereby also the outer dimensions of the crusher itself are increased. This is not desirable.

### SHORT DESCRIPTION OF THE INVENTION

For solving the problems of the prior art there is now invented a hydraulically adjustable cone crusher in accordance with claim 1 and an axially arranged axial bearing assembly of the crusher in accordance with claim 7.

In the solution in accordance with the present invention, the pressure medium required for adjusting the setting of the crusher is supplied to pressure medium channel included in the pressure medium space of the adjustment cylinder, said pressure medium channel extending from the lower axial bearing mounted to the upper end of the main shaft of the crusher through a stiff pipe or hose included in the lubricant channel going inside the main shaft of the crusher. Thus, the pipe or the hose is not subject to movement and wearing caused by that during the operation.

In the solution in accordance with the invention, more simple solutions can be used for supplying the pressure medium to the pressure medium space than in the described solutions of prior art. Thus, the solution in accordance with the present invention is more durable, more reliable and cheaper than the solution of prior art disclosed in said Finnish patent application.

In the crusher in accordance with the invention, smaller lead-through channels can be formed for the pressure medium into the bearing surfaces of the axial bearing assembly, than those of the prior art. Thereby a bigger bearing capacity of the axial bearing assembly is provided, and, consequently, a bigger capacity of the crusher.

In addition, the crusher in accordance with the invention is more easily mountable and dismountable than the crusher known in prior art.

More precisely, the crusher in accordance with the present invention is characterized by what is stated in the characterizing part of claim 1, and the axial bearing assembly in accordance with the present invention is characterized by what is stated in the characterizing part of claim 7.

### BRIEF DESCRIPTION OF THE DRAWINGS

The invention will be described in more detail in the following, with reference to the enclosed drawings, wherein:

FIG. 1 shows as a cross-sectional view one cone crusher of prior art,

FIG. 2 shows as a cross-sectional view another cone crusher of prior art,

FIG. 3 shows as a cross-sectional view a cone crusher in accordance with one embodiment of the present invention,

FIG. 4 shows an enlarged detail of the cone crusher of FIG. 3,

FIG. 5 shows as a cross-sectional view a cone crusher in accordance with another embodiment of the present invention,

FIG. 6 shows an enlarged detail of the cone crusher of FIG. 5,

FIGS. 7 and 8 show details of some preferred embodiments of the present invention.

### DETAILED DESCRIPTION OF THE INVENTION

Main parts of the crushers of FIGS. from 1 to 6 are:
lower frame 1,
upper frame 2,
main shaft 3,
crushing head, i.e. support cone 4,
outer crushing tool 5,
inner crushing tool 6,
crushing chamber 7,
eccentric shaft 8,
gearwheel of the eccentric shaft 9,
outer radial bearing bushing 10,
inner radial bearing bushing 11,
adjustment cylinder 12,
adjustment piston 13,
protective bushing 14,
lubricant channel 15,
supply hose for pressure medium 16,
upper axial bearing 17,
lower axial bearing 18,
pressure medium space 19,
dust sealing 20,
pressure medium channel of the adjustment piston 21
pressure medium channel of the adjustment cylinder 22
pressure medium supply pipe 31
lubricant channel of the eccentric shaft 41,
sealing ring of the axial bearing assembly 42,
sealing ring of the adjustment piston 43,
connector 44,
pressure medium channel 45,
lubricant space 46,
sealing ring of the adjustment cylinder 61
groove of the sealing ring 71,
sealing part of the sealing ring 81,
flexing part of the sealing ring 82.

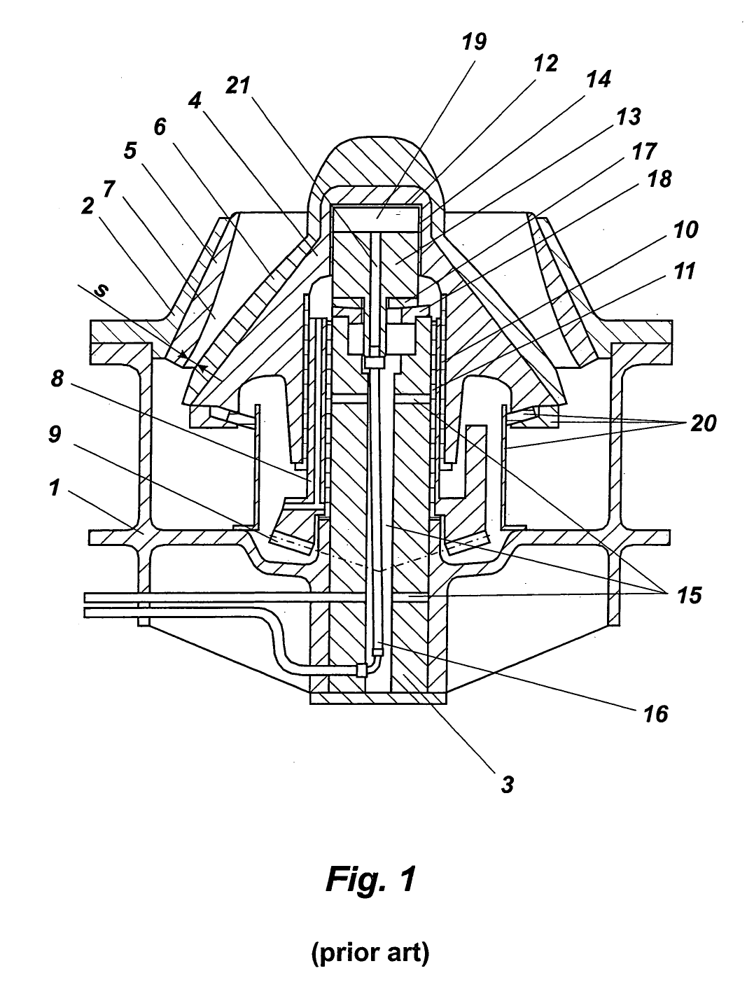

In FIGS. 1, 2, 3 and 5, the setting of the crusher is marked with s.

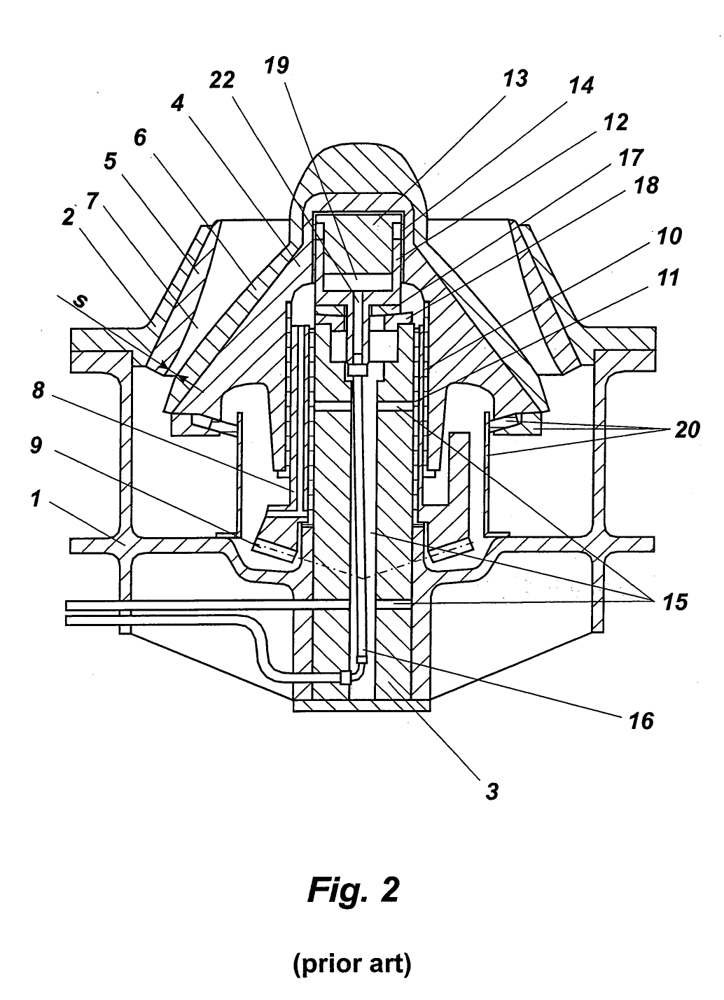

The frame of the crusher shown in FIGS. 1 and 2 is formed from two main units: the lower frame 1 and the upper frame 2. The outer crushing tool 5 attached to the upper frame and the inner crushing tool 6 attached to the main shaft 3 via crushing head, in other words via support cone 4, form the crushing chamber 7, to which the material to be crushed is fed from above the crusher.

The main shaft 3 of the crusher is attached immobile to the lower frame of the crusher. The eccentric shaft 8 is attached to the main shaft rotatably, rotated by the driving device (not shown) and the power transmission (for purpose of simplifying also not shown) via gear wheel 9. The central axis of the central aperture of the eccentric shaft 8 is with respect to the central axis of the outer surface of the eccentric shaft inclined or parallel on a different axis. When the crusher is operating and the eccentric shaft rotating about the central axis of the main shaft 3 of the crusher, around the main shaft 3, the crushing head 4 mounted rotatably on the eccentric shaft, gets in a horizontal oscillating or gyratory motion with respect to the frame 1 of the crusher and the main shaft 3.

More precisely, the inclination of the inner aperture of the eccentric shaft 8 here means that the central axis of the inner aperture of the eccentric shaft is inclined with respect to the central axis of the outer surface of the eccentric shaft.

Bearing bushings 10, 11 are usually used between the main shaft 3 of the crusher and the eccentric shaft 8, and between the eccentric shaft and the crushing head 4. The horizontal crushing forces exerted to the crushing head 4 are transmitted to the frame 1 of the crusher via the main shaft 3, the eccentric shaft 8 and the bearing bushings 10, 11, eventually used between the same.

In the space defined by the crushing head 4 and the main shaft 3 of the crusher, there is provided a space for the hydraulic cylinder/piston assembly 12, 13 of the hydraulic setting adjustment and safety system of the crusher. The vertical crushing forces exerted by the crushing to the crushing head 4 are transmitted to frame 1 of the crusher by the crushing head via adjustment cylinder 12 and adjustment piston 13 and via pressure medium in the pressure medium space 19 remaining between them, as well as via axial bearing assembly 17, 18 of the crusher. The axial bearing assembly comprises usually two axial bearings, namely upper axial bearing 17 and lower axial bearing 18, arranged slidably with respect to each other, the respective contacting surface between them forming the sliding surface, i.e. bearing surface of the axial bearing assembly.

The setting s of the crusher is reducingly adjustable by pumping pressure medium to the pressure medium space 19 of the hydraulic cylinder/piston assembly 12, 13 of the hydraulic setting adjustment and safety system. Correspondingly, the setting s of the crusher is increasingly adjustable by discharging pressure medium from the pressure medium space 19. A combined pressurizing and lubricating device of the crusher (not shown), known in the art, is preferably used as a pressure source.

A protective bushing 14 can be used on the surface of the space formed for the adjustment cylinder 12 and piston 13 in the crushing head in order to protect the crushing head from wearing.

The essential difference between the crushers of FIGS. 1 and 2 representing the prior art is how 'the adjustment cylinder 12 and the adjustment piston 13 are disposed with respect to each other. In the crusher in accordance with FIG. 1, the adjustment piston 13 rests on the main shaft, supported by the axial bearing assembly 17, 18. In the crusher in accordance with FIG. 2, the adjustment cylinder 12 rests on the main shaft, supported by the axial bearing assembly.

In the crusher in accordance with FIG. 1, a pressure medium channel 21 is formed inside the adjustment piston 13, for leading the pressure medium through it to the pressure medium space 19 of the hydraulic cylinder/piston assembly 12, 13 of the hydraulic setting adjustment and safety system of the crusher. The pressure medium channel of the adjustment piston forms a pipe-like extension to the lower end of the piston 13, extending through the upper and lower axial bearing 17, 18 of the axial bearing assembly and being connected at its lower end to the supply hose 16 of the pressure medium extending inside the lubricant channel 15. Because the adjustment piston moves in operation together with the crushing head 4 laterally with respect to the frame, the central aperture of the lower axial bearing 18 has been made large, so as to allow the motion of the pipe-like extension of the lower end of the piston 13. A drawback of this solution is that the supporting area of the bearing surfaces of the axial bearing assembly 17, 18 remains quite small with respect to their total surface area, whereby the ability of the crusher to receive vertical crushing forces remains small. This means, in practice, decreasing capacity of the crusher. Compensation of the effect of the large central aperture, again, requires, that the outer diameters of the bearing surfaces of the axial bearing assembly must be increased, whereby also the outer dimensions of the crusher increase. This is not desirable.

Further, because the adjustment piston moves in operation together with the crushing head 4 laterally, a flexible hose 16 must be used as a supply line for the pressure medium. The construction is demanding for the pressure medium hose to be used. It must withstand many kinds of stresses: bending, twisting, pulsating changes of the pressure as well as fatigue loading caused by these together and separately. Thus, these solutions turn out to be unreliable in operation. In case the above-mentioned drawbacks should be eliminated by the hose design, construction and material choices, the solution will also be expensive.

In the crusher in accordance with FIG. 2, the supply of the pressure medium to the pressure medium space 19 of the hydraulic cylinder/piston assembly 12, 13 of the hydraulic setting adjustment and safety system of the crusher through the upper and lower axial bearing 17, 18 of the axial bearing assembly is arranged nearly in the same way as in the crusher of FIG. 1. The difference is only that in the crusher of FIG. 2 the pressure medium channel 22 is formed into the adjustment cylinder 12. In this case the pressure medium channel of the adjustment cylinder forms into the lower end of the cylinder 12 a pipe-like extension extending through the upper and lower axial bearing 17, 18 of the axial bearing assembly to be connected at its lower end to the pressure medium supply hose 16 extending inside the lubricant channel 15. In the crusher of FIG. 2, the adjustment cylinder 12 moves in operation together with the crushing head 4 laterally with respect to the frame of the crusher, whereby also in this case the central aperture of the axial bearing 18 has been made large, so as to allow the motion of the pipe-like extension of the lower end of the cylinder 12. For the pressure medium supply hose 16 this solution sets the same requirements as the solution of FIG. 1.

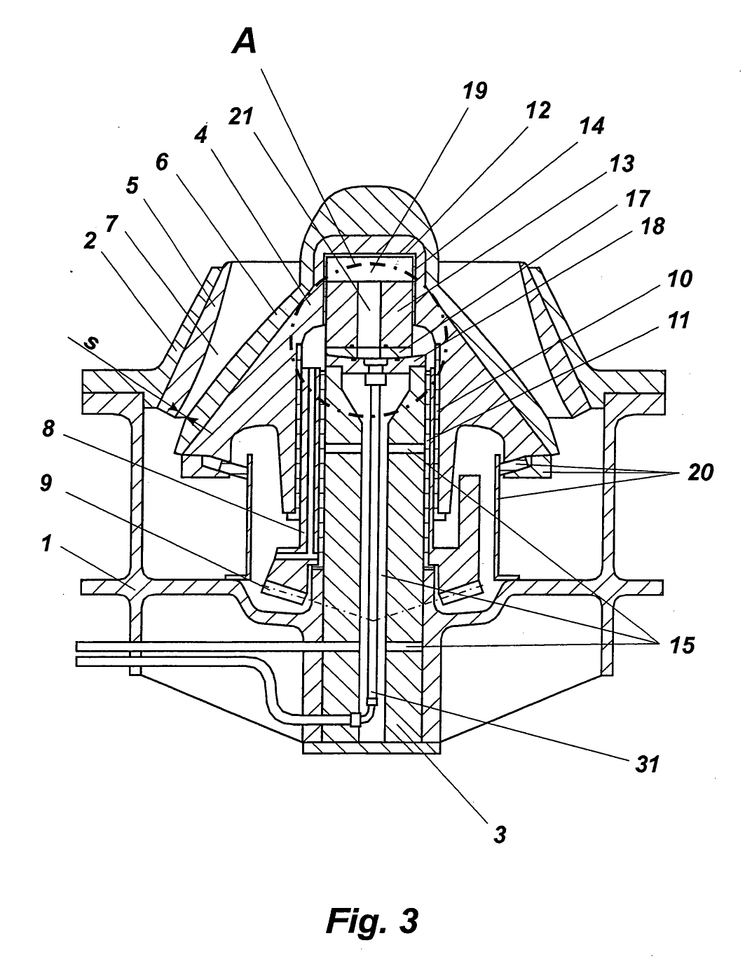

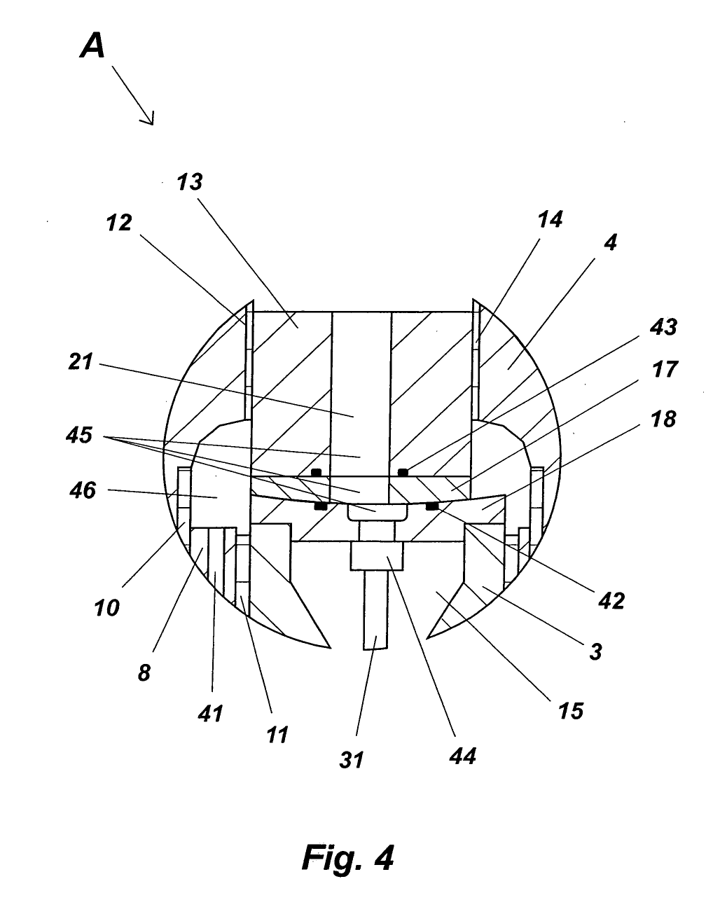

FIG. 3 shows as a cross-sectional view a cone crusher in accordance with one embodiment of the present invention, and FIG. 4 shows point A of the cone crusher of FIG. 3 as an enlarged view. The essential difference of the embodiment of the invention shown in FIGS. 3 and 4 with respect to the closest embodiment of prior art shown in FIG. 1 is how the supply of the pressure medium is provided through the axial bearing assembly 17, 18 to the pressure medium space 19 of the hydraulic cylinder/piston assembly 12, 13 of the hydraulic setting adjustment and safety system of the crusher. The pressure medium channel 21 of the adjustment piston 13 does not form any pipe-like extension to the lower end of the piston. The pressure medium supply pipe 31 is not connected at its upper end to the adjustment piston, but to the lower axial bearing 18 of the axial bearing assembly 17, 18. A pressure medium channel 45 is formed into the adjustment piston 13 and the axial bearing assembly 17, 18 as a series of simple apertures opening to each other so, that no extensions that would extend from one part to another have been formed to the piston 13 or to either of the axial bearings 17, 18. Thus, the pressure medium space of the solution in accordance with the invention is formed, except by the pressure medium space 19 of the hydraulic cylinder/piston assembly, by the apertures in the axial bearings 17 and 18, in other words, the pressure medium channels 45.

The pressure medium channel 45 is separated from the lubricant space 46 by means of a sealing ring 42 of the axial bearing assembly, to keep the pressurized pressure medium inside the channel so, that pressure medium cannot be discharged significantly from the pressure medium channel to the lubricant space 46, and that the adjustment pressure in the pressure medium space 19 cannot be decreased and the setting of the crusher correspondingly increased. The sealing ring 42 also prevents the pressure medium and lubricant from mixing with each other significantly, although the invention is preferably implemented so that the pressure medium and the lubricant are of the same material, whereby minor leakage of the pressure medium from the pressure medium space 45 to the lubricant space 46 is not significant.

In the embodiment of the invention in accordance with FIGS. 3 and 4, the pressure medium channel 45 is additionally separated from the lubricant space 46 with a sealing ring 43 of the adjustment piston for preventing the pressure medium from discharging from the pressure medium channel between the adjustment piston 13 and the upper axial bearing 17.

The function of the lubricant channel 15—including the lubricant space 46 inside the crushing head 4—is to lead lubricant onto the sliding surfaces of the crusher, located at least between the main shaft 3 and the eccentric shaft 8, between the eccentric shaft and the crushing head 4, between the adjustment piston 13 and the main shaft 3, on the surfaces of bearing elements 10, 11, 17, 18 attached to these, on the surfaces of the dust sealing arrangement 20 and on the surfaces of the gear wheel 9 of the eccentric shaft and the power transmission (not shown). The lubricant channels 15 comprise in addition the apertures (not shown) formed to the lower axial bearing 18, allowing the lubricant to penetrate to the sliding surfaces of the axial bearing assembly 17, 18, as well as the lubricant channel 41 at the eccentric shaft allowing the lubricant to get from the lubricant space 46 to the gearwheel 9 of the eccentric shaft, to the power transmission of the crusher and to the dust sealing 20.

It is clear to those skilled in the art, that the invention is in no way limited to any definite number of the bearing elements 17, 18 or sealing rings 42, 43 of the axial bearing assembly. The invention can also be implemented for example so that the adjustment piston 13 and the upper axial bearing 17 are formed from one and the same part, whereby the sealing 43 is not needed. It must also be understood, that when the number of the bearing elements 17, 18 on top of each other is increased, also at least as many seals are needed as there is the number of slide surfaces between the bearing elements. Further, it is clear that also two or more sealing rings with different diameters within each other can be located between the bearing surfaces.

As there is no extension in the adjustment piston extending through the sliding surface of the axial bearing assembly 17, 18, the apertures of the pressure medium channel formed to the axial bearing assembly can be dimensioned smaller than in the crushers known in the art. Thus, a larger supporting area of the bearing elements can be reached with smaller total diameter of the bearing elements, than in the crushers of prior art. In the dimensioning of the apertures of the pressure medium channel 45 it is essential to take into account the length of the stroke of the crusher caused by the eccentric arrangement of the eccentric shaft 8, that is the maximum shift of the bearing elements laterally with respect to each other. The apertures must be dimensioned so that the pressure medium channel 45 remains open in all situations to make the apertures of the channel to open to each other.

The length of the stroke must also be taken into account when dimensioning the sealing rings 42, 43 in connection with the pressure medium channel. It is essential, that the sealing rings set in every working condition between the bearing surfaces, and not for example at the apertures of the pressure medium channel or outside a bearing surface of any bearing element 17, 18.

The connection between the pressure medium supply pipe 31 and the lower axial bearing 18 can be implemented demountably with a connector 44. As the lower axial bearing does not move substantially with the adjustment piston 13 with respect to the frame 1 of the crusher and thus with respect to the pressure medium supply pipe 31 when the crusher is in operation, prominently smaller stresses are exerted to the pressure medium supply pipe than in the known crushers of prior art. In the embodiment of the invention in accordance with FIGS. 3 and 4, the construction, design and material of the pressure medium supply pipe can be chosen much more freely than in the crushers of prior art. For example a simple metallic or plastic pipe commercially available or a usual hydraulic hose or pipes made of different layer materials or composite constructions can be used as supply pipe.

Preferably the upper axial bearing 17 and the adjustment piston 13 are demountably attached to the crushing head 4 of the crusher so, that when mounting and demounting the crusher, all said three parts can be lifted to the crusher/from the crusher as one assembly.

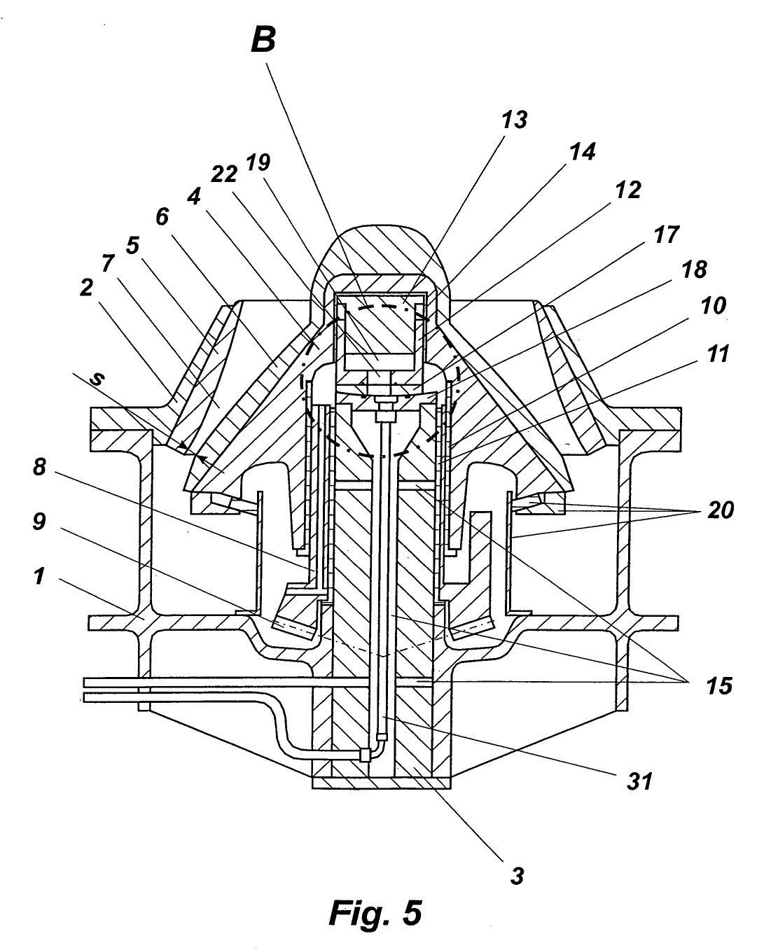

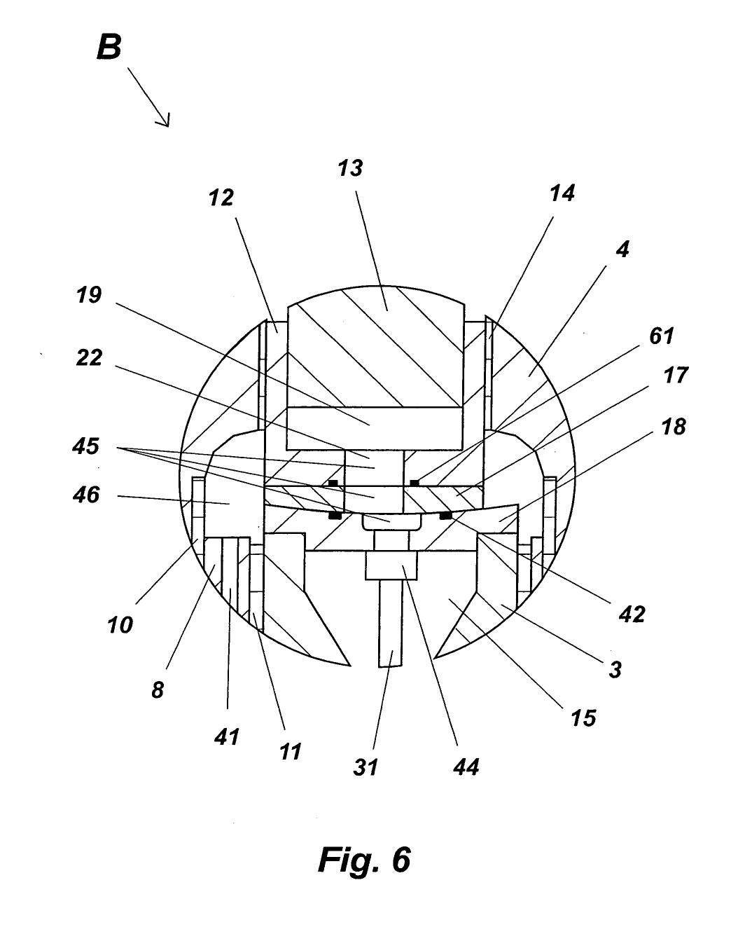

FIG. 5 shows as a cross-sectional view a cone crusher in accordance with another embodiment of the present invention, and FIG. 6 shows an enlarged detail of point B of the cone crusher of FIG. 5.

The essential difference of the embodiment of the invention shown in FIGS. 5 and 6 with respect to the embodiment shown in FIGS. 3 and 4 is how the adjustment cylinder 12 and the adjustment piston 13 are arranged with respect to each other. In the crusher of FIGS. 3 and 4, the adjustment piston 13 rests on the main shaft of the crusher, supported by the axial bearing assembly. In the crusher in accordance with FIGS. 5 and 6, the adjustment cylinder 12 rests on the main shaft of the crusher, supported by the axial bearing assembly.

The essential difference of the embodiment of the invention shown in FIGS. 5 and 6 with respect to the closest embodiment of prior art shown in FIG. 2 is how the supply of the pressure medium is provided through the axial bearing assembly 17, 18 to the pressure medium space 19 of the hydraulic cylinder/piston assembly 12, 13 of the hydraulic setting adjustment and safety system of the crusher. The pressure medium channel 22 of the adjustment cylinder 12 does not form any pipe-like extension to the lower end of the piston. The pressure medium supply pipe 31 is not connected at its upper end to the adjustment cylinder, but to the lower axial bearing 18 of the axial bearing assembly 17, 18. A pressure medium channel 45 is formed into the adjustment cylinder 12 and the axial bearing assembly 17, 18 as a series of simple apertures opening to each other so, that no extensions that would extend from one part to another have been formed to the cylinder 12 or to either of the axial bearings 17, 18. Thus, the pressure medium space of the solution in accordance with the invention is formed, except by the pressure medium space 19 of the hydraulic cylinder/piston assembly, also by the apertures in the axial bearings 17 and 18, in other words, the pressure medium channels 45.

The pressure medium channel 45 is separated from the lubricant space 46 by means of a sealing ring 42 of the axial bearing assembly, that keeps the pressurized pressure medium inside the channel so, that pressure medium cannot be discharged significantly from the pressure medium channel to the lubricant space 46, and that the adjustment pressure in the pressure medium space 19 cannot be decreased and the setting of the crusher correspondingly increased. The sealing ring 42 also prevents the pressure medium and lubricant from mixing with each other significantly, although the invention is preferably implemented so that the pressure medium and the lubricant are of the same material, whereby minor leakage of the pressure medium from the pressure medium space 45 to the lubricant space 46 is not significant.

In the embodiment of the invention in accordance with FIGS. 5 and 6, the pressure medium channel 45 is additionally separated from the lubricant space 46 with a sealing ring 61 of the adjustment cylinder for preventing the pressure medium from discharging from the pressure medium channel between the adjustment cylinder 12 and the upper axial bearing 17.

The function of the lubricant channel 15—including the lubricant space 46 inside the crushing head 4—is to lead lubricant onto the sliding surfaces of the crusher, located at least between the main shaft 3 and the eccentric shaft 8, between the eccentric shaft and the crushing head 4, between the adjustment cylinder 12 and the main shaft 3, on the surfaces of bearing elements 10, 11, 17, 18 attached to these, on the surfaces of the dust sealing arrangement 20 and on the surfaces of the gear wheel 9 of the eccentric shaft and the power transmission (not shown). The lubricant channels 15 comprise, in addition, the apertures (not shown) formed to the lower axial bearing 18, allowing the lubricant to penetrate to the sliding surfaces of the axial bearing assembly 17, 18, as well as the lubricant channel 41 allowing the lubricant to get from the lubricant space 46 to the gear wheel 9 of the eccentric shaft, to the power transmission of the crusher and to the dust sealing 20.

It is clear to those skilled in the art, that the invention is in no way limited to any definite number of the bearing elements 17, 18 or sealing rings 42, 61 of the axial bearing assembly. The invention can also be implemented for example so that the adjustment cylinder 12 and the upper axial bearing 17 are formed from one and the same part, whereby the sealing 61 is not needed. It must also be understood, that when the number of the bearing elements 17, 18 on top of each other is increased, also at least as many seals are needed as there is the number of slide surfaces between the bearing elements. Further, it is clear that also two or more sealing rings with different diameters within each other can be located between the bearing surfaces.

As there is no extension in the adjustment cylinder that would extend through the sliding surface of the axial bearing assembly 17, 18, the apertures of the pressure medium channel formed to the axial bearing assembly can be dimensioned smaller than in the crushers known in the art. Thus, a larger supporting area of the bearing elements can be reached with smaller total diameter of the bearing elements, than in the crushers of prior art. In the dimensioning of the apertures of the pressure medium channel 45 it is essential to take into account the length of the stroke of the crusher caused by the eccentric arrangement of the eccentric shaft, that is the maximum shift of the bearing elements 17, 18 laterally with respect to each other. The apertures must be dimensioned so that the pressure medium channel 45 remains open in all situations to make the apertures of the channel to open to each other.

The length of the stroke must also be taken into account when dimensioning the sealing rings 42, 61 in connection with the pressure medium channel. It is essential, that the sealing rings set in every working condition between the bearing surfaces, and not for example at the apertures of the pressure medium channel or outside a bearing surface of one bearing element 17, 18.

The connection between the supply pipe 31 and the lower axial bearing 18 can be implemented demountably with a connector 44. As the lower axial bearing does not move substantially with the adjustment cylinder 12 with respect to the frame 1 of the crusher and thus with respect to the pressure medium supply pipe 31, when the crusher is in operation, prominently smaller stresses are exerted to the pressure medium supply pipe than in the known crushers of prior art. In the embodiment of the invention in accordance with FIGS. 5 and 6, the construction, design and material of the pressure medium supply pipe can be chosen much more freely than in the crushers of prior art. For example a simple metallic or plastic pipe commercially available or a usual hydraulic hose or pipes made of different layer materials or composite constructions can be used as supply pipe.

Preferably the upper axial bearing 17 and the adjustment cylinder 12 and the adjustment piston 13 are demountably attached to the crushing head 4 of the crusher so, that when mounting and demounting the crusher, all said four parts can be lifted to the crusher/from the crusher as one assembly.

For the functionality of the invention it is essential, that the construction, form and material of the sealing rings 42, 43, 61 are correctly chosen. The sealing rings must maintain their sealing properties in especially demanding circumstances.

The sealing is exposed to the pressure of the pressure medium of the hydraulic setting adjustment and safety system of the crusher, said pressure being during the crushing operation usually from 7 to 15 MPa, in over-load situations momentarily even 40 MPa. To have a proper sealing capacity against the pressure of the pressure medium, the pressing force between the sealing ring and its stop face must be suitable for the application. For those skilled in the art, it is clear, that the sealing material 42 and the material of the stop face 17, 18 must be chosen so that their unreasonable mutual wearing can be avoided. The point is that the bearing surface 17, 18 must wear as much at a point where the sealing ring 42 is against it, as at a point, where, instead of the sealing ring 42, another bearing surface 17, 18 is against it.

The temperature of the pressure medium rises during the crushing usually to 330-370 Kelvin degrees. In an overload situation of the crusher the temperature in the axial bearing assembly 17, 18 and accordingly also in the sealing rings 42, 43, 61 can momentarily and locally rise much higher, even to 470 Kelvin degrees. Correspondingly, the temperature of a crusher standing in winter conditions can go very low, for example to 240 Kelvin degrees. Consequently, the wear hardness, friction and elasticity properties of the sealing rings 42, 43, 61 must remain as even as possible in the temperature changes of the sealing rings.

The material or materials of the sealing ring must naturally be also from the point of view of their chemical properties suitable for use in each application together with the appropriate pressure medium and lubricant. In addition, a low friction coefficient is required from the sealing material when it cooperates with the sliding surface. Further, the effect known to those skilled in the art as “stick-slip-effect” must not occur significantly between the sealing material and its sliding surface.

The axial bearing pair 17, 18 is formed of two metals with different hardness. Usually, one bearing element of the pair is made of steel and the other of bronze. This must be taken into account when choosing the material of the sealing ring.

The material of the sealing ring can be chosen based on the requirements set above, for example among commercially available sealing materials. Especially suitable materials for the seals are polymer materials, especially thermoplastic materials designed for sealing use.

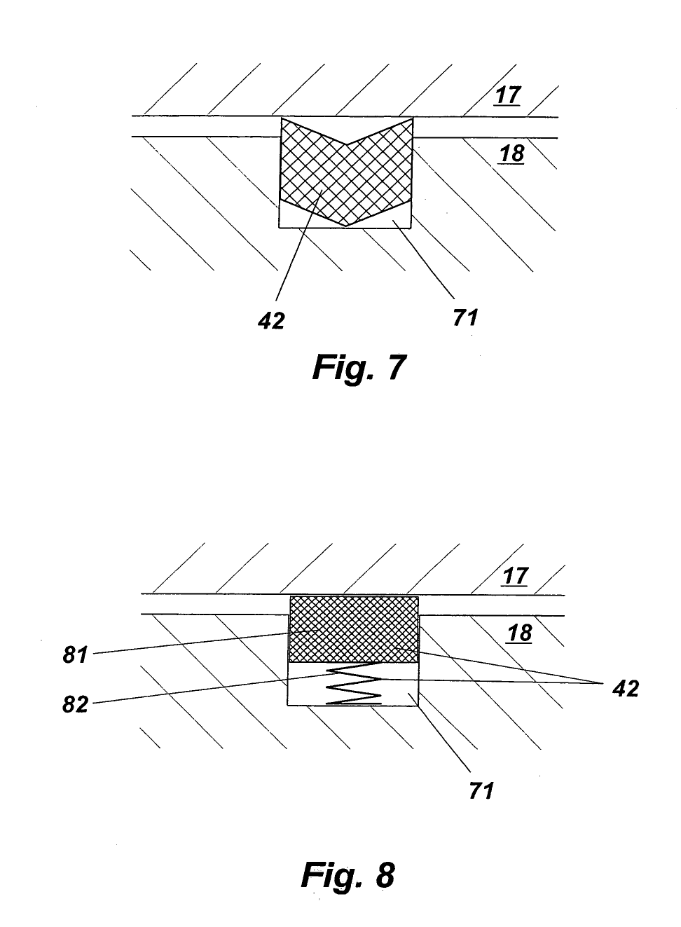

FIG. 7 shows a structural solution of a sealing ring 42 in accordance with one preferred embodiment of the invention. The sealing ring 42 sets itself into a groove 71 formed into the bearing element 18. Preferably the cross section of the sealing ring is formed so, that when it sets itself into the groove 71, it is pressed strongly between the bottom of the groove and the bearing surface of the axial bearing 17 facing it. As an example of this kind of a cross section of the seal 42, FIG. 7 shows a cross section of a sealing ring having substantially a V form. The peak of the V bottom is pressed strongly to the bottom of the groove 71 and the upper peaks of the V are pressed strongly against the stop face of the sealing ring.

FIG. 8 shows a structural solution of a sealing ring 42 in accordance with one preferred embodiment of the invention. The sealing ring 42 is comprised of at least two parts with different properties, of a sealing part 81 of the sealing ring and of a flexing part 82 of the sealing ring, being made of different materials or having a different structure. Purpose of the flexing part 82 is to secure the optimal pressing force of the sealing ring 42 and its stop face and thus to secure the best possible sealing performance and wearing property, in other words, service life. Purpose of the sealing part 81 is to secure the best possible wearing property of the sealing ring 42 and its stop face and thus the best possible sealing performance.

The flexibility of the sealing part 82 can be based except on the properties of the material of the flexing part, also on its mechanically flexible structure. The flexing part 82 can thus be for example of appropriate rubber. Alternatively, the flexing part 82 can also be of solid metal, having, anyway, a mechanically flexible structure.

It is clear for those skilled in the art, that the invention is in no way limited to any definite location of the sealing ring 42, 43, 61 and the groove 71 for it. The groove for the sealing ring can be formed into any element 12, 13, 17, 18 forming the pressure medium space 45 or into the stop face thereof. Correspondingly, the sealing ring 42, 43, 61 can be located to any groove for sealing ring of an element 12, 13, 17, 18 forming the pressure medium channel so, that the sealing ring and its stop face together form a pair of sealing faces.

The power transmission left out of the FIGS. 1, 2, 3 and 5 for emphasizing the essential features of the invention can be of a usual type known in the art. This kind of power transmission solutions have been disclosed for example in the Finnish patent application No. 20031509.

The invention is not limited to any definite pressure medium or lubricant. Preferably the pressure medium and lubricant are of one and the same material, for example of commercially available hydraulic oils known in the art.

It is clear for those skilled in the art, that the invention is suitable for crushing of stone or other hard mineral materials, like ore or gravel, but not limited to those. It is also clear, that the cone crusher in accordance with the invention can be used for crushing of many other kinds of feed material, such as recyclable construction waste like brick, concrete and asphalt, for crushing of coke or glass, as well as for crushing of other hard materials having same kind of physical properties as the mineral materials.

It is clear for those skilled in the art, that the invention can also be implemented so that the pressure medium needed for the adjustment of the crusher and the lubricant needed for the lubrication of the crusher will change their supply channels with each other. The invention can also be implemented so that there is a pressure medium channel formed into the main shaft of the crusher, a separate hose or pipe being provided inside said pressure medium channel for supplying the lubricant needed for the lubrication of the crusher.

Further, it is clear for those skilled in the art, that in the embodiment of FIG. 5, the adjustment piston 13 can be formed into the crushing head 4 itself so, that no separate adjustment piston is needed.

1. A hydraulically adjustable cone crusher comprising:
a frame,
a main shaft mounted at its lower part immobile with respect to the frame,
an eccentric shaft mounted to be rotated about the central axis of the main shaft, around the main shaft,
a crushing head mounted rotatably on the eccentric shaft,
an inner crushing tool mounted on the crushing head,
an outer crushing tool mounted in the frame,
a crushing chamber formed between the outer and inner crushing tool for crushing the feeding material, and
an adjustment cylinder/piston assembly of a hydraulic adjustment system of the crusher for defining the vertical position of the crushing head with respect to the main shaft, said adjustment cylinder/piston assembly being mounted in the space formed between the crushing head and the upper surface of the main shaft,
characterized in that the pressure medium of the hydraulic adjustment system of the crusher is supplied to the pressure medium space formed, except by the adjustment cylinder/piston assembly, also by at least one bearing element.

2. A crusher in accordance with claim 1, characterized in that the number of the bearing elements is at least two.

3. A crusher in accordance with claim 2, characterized in that between the surfaces of the lower axial bearing and the upper axial bearing facing each other there is located at least one sealing ring.

4. A crusher in accordance with claim 1, characterized in that between the surfaces of the upper axial bearing and the adjustment piston facing each other there is located at least one sealing ring.

5. A crusher in accordance with claim 1, characterized in that between the surfaces of the upper axial bearing and the adjustment cylinder facing each other there is located at least one sealing ring.

6. A crusher in accordance with claim 1, characterized in that the hydraulic pressure medium and the lubricant are of one and the same material.

7. Axially arranged axial bearing assembly of a cone crusher adjusted hydraulically, said axial bearing assembly comprising an upper axial bearing and a lower axial bearing and at least one aperture for supplying pressure medium through the axial bearing assembly, characterized in that between the surfaces of the lower axial bearing and the upper axial bearing facing each other there is located at least one sealing ring.

8. Axial bearing assembly in accordance with claim 7, characterized in that at least one sealing ring is located between the upper axial bearing and the surface facing its upper surface.

9. Axial bearing assembly in accordance with claim 7, characterized in that the sealing ring is at least partly mortised into at least one of the surfaces facing each other.

10. Axial bearing assembly in accordance with claim 9, characterized in that the sealing ring is provided with a flexing part.

11. A crusher in accordance with claim 2, characterized in that between the surfaces of the upper axial bearing and the adjustment piston facing each other there is located at least one sealing ring.

12. A crusher in accordance with claim 3, characterized in that between the surfaces of the upper axial bearing and the adjustment piston facing each other there is located at least one sealing ring.

13. A crusher in accordance with claim 2, characterized in that between the surfaces of the upper axial bearing and the adjustment cylinder facing each other there is located at least one sealing ring.

14. A crusher in accordance with claim 3, characterized in that between the surfaces of the upper axial bearing and the adjustment cylinder facing each other there is located at least one sealing ring.

15. A crusher in accordance with claim 2, characterized in that the hydraulic pressure medium and the lubricant are of one and the same material.

16. A crusher in accordance with claim 3, characterized in that the hydraulic pressure medium and the lubricant are of one and the same material.

17. A crusher in accordance with claim 4, characterized in that the hydraulic pressure medium and the lubricant are of one and the same material.

18. A crusher in accordance with claim 5, characterized in that the hydraulic pressure medium and the lubricant are of one and the same material.

19. Axial bearing assembly in accordance with claim 8, characterized in that the sealing ring is at least partly mortised into at least one of the surfaces facing each other.
